(19) United States
(12) Patent Application Publication
(10) Pub. No.: US 2023/0143846 A1
(43) Pub. Date: May 11, 2023

(54) INTELLIGENT NOTIFICATION ROUTER

(71) Applicant: Pivot Industries Limited, Roxborough, CO (US)

(72) Inventor: James M. Miller, Roxborough, CO (US)

(21) Appl. No.: 17/812,839

(22) Filed: Jul. 15, 2022

Related U.S. Application Data
(60) Provisional application No. 63/222,254, filed on Jul. 15, 2021.

(51) Int. Cl. H04L 51/224; H04L 51/23

(52) U.S. Cl. CPC H04L 51/224; H04L 51/23

(57) ABSTRACT

A system (100) and associated functionality provide intelligent notifications in a network. Such notifications can include an embedded interactive element to allow immediate execution of actions. The system (100) generally includes an intelligent notification routing platform (102) that interacts with a number of user devices (104). One or more of the user devices (104) may submit an intelligent notification routing request (106) to the platform (102). The platform (102) processes the request and routes intelligent notification messages (108) to one or more of the user devices (104). The illustrated intelligent notification message (108) includes an interactive element (110). A user can use the interactive element (110) to execute a variety of functionality.

### CROSS-REFERENCE TO RELATED APPLICATION

This application claims benefit of U.S. Provisional Pat. Application No. 63/222,254, entitled, “INTELLIGENT NOTIFICATION ROUTER”, filed Jul. 15, 2021, the contents of which are hereby incorporated by reference in their entirety.

### FIELD OF THE INVENTION

The present invention relates generally to routing notifications to recipients in a communications network and, in particular, to routing of intelligent notifications that include embedded intelligent elements to enable a call to action, a form response, or intelligent distribution to multiple recipients with different notification contingencies and/or obligations.

### BACKGROUND OF THE INVENTION

A variety of notification messaging systems have been developed in communications networks including text messages, email, and instant messaging. Some of these notification messaging systems are particularly well-suited to generating timely responses due to immediate notifications including text messaging, instant messaging, and similar systems. Such systems are often used by groups, companies, and other organizations in contexts where a timely response is important including emergency response situations and timely addressing business needs and customer inquiries. Indeed, in some cases, messaging is preferred even over meetings or phone calls, particularly when a situation requires action by multiple individuals and/or multiple discrete actions.

As an example of an emergency response, consider the case of an emergency on an airport runway. A response may require containment teams, emergency response units, and hazmat teams. Moreover, a dispatcher may require confirmations that initial response teams have been deployed or that initial containment processes have been completed. Thus, multiple teams may require notifications and instructions, and multiple confirmations may be required. Conventionally, this may involve a series of phone calls or other voice communications. However, such voice communications take time and may be executed as a series of conversations rather than concurrently, thereby further increasing the response time.

Similar concerns apply in non-emergency settings that are nonetheless time sensitive. For example, a business may receive a time-sensitive request for proposal. The response may require a series of actions and approvals by different members of the organization. For example, managers may be required to indicate terms such as delivery date and price, others may be required to confirm availability of materials and other resources, still others may need to provide preliminary approvals and final approvals at various steps in the process. It will be appreciated that coordinating and executing these actions can be time consuming and can impair an organization’s ability to provide a timely response. Even in settings that are not time sensitive, it may be difficult to manage such processes, particularly multilateral processes involving multiple actions by multiple individuals.

### SUMMARY OF THE INVENTION

The present invention is directed to a system and associated functionality for providing intelligent notifications. Such notifications can include an embedded interactive element to allow immediate execution of actions. Moreover, notifications can be intelligently distributed to different individuals to prompt a variety of actions over time, thereby streamlining even complex, multilateral responses. The invention thereby facilitates timely and well-organized responses with reduced distractions due to misdirected or premature notifications.

In accordance with one aspect of the present invention, a system and associated functionality (“utility”) is provided for processing notifications in a communications network. The utility involves receiving, via the communications network, a notification request from a sender where the notification request includes instructions for distributing a notification and for prompting one or more responses. Based on the instructions, the utility identifies one or more recipients for the notification request, generates one or more notification messages, and embeds a first interactive element into at least a first notification message. For example, the first notification message may be a text or instant message. The first notification message is then routed to at least a first recipient and a response from the first recipient is received based, at least in part, on selection of the first interactive element.

The embedded interactive element may include, for example, a call to action, a form response, or may be part of an intelligent distribution process. In this regard, the first interactive element may include a call to action wherein the response is executed by selecting the first interactive element. For example, the first interactive element may indicate an acknowledgment or an approval. Alternatively, the first interactive element may include a form response where the first recipient interacts via the first interactive element to enter information to execute the response. For example, the first recipient may populate data fields or complete a form. As a further alternative, notification messages may be routed to multiple recipients wherein such routing to at least one of the recipients is contingent on satisfaction of a condition. For example, the system may wait to send a notification message to one of the recipients until another recipient has acted upon or approved a prior notification. In this manner, the intelligent notifications can be used to prompt a timely response from recipients or even to execute complex, multilateral processes.

### BRIEF DESCRIPTION OF THE DRAWINGS

For a more complete understanding of the present invention, and further advantages thereof, reference is now made to the following detailed description, taken in conjunction with the drawings, in which:

FIG. 1 is a schematic diagram of a network for implementing an intelligent notification routing system in accordance with the present invention;

FIG. 2 illustrates an intelligent notification message in accordance with the present invention; and

FIGS. 3-5 illustrate various intelligent notification routing contexts in accordance with the present invention.

### DETAILED DESCRIPTION

In the following description, the invention as set forth with respect to specific examples of network environments and specific examples of intelligent notification routing contexts. These examples are intended to assist in providing an understanding of the present invention. However, it will be appreciated that the invention is not limited to such network environments and intelligent notification routing contexts. Accordingly, the following description should be understood as exemplary and not by way of limitation.

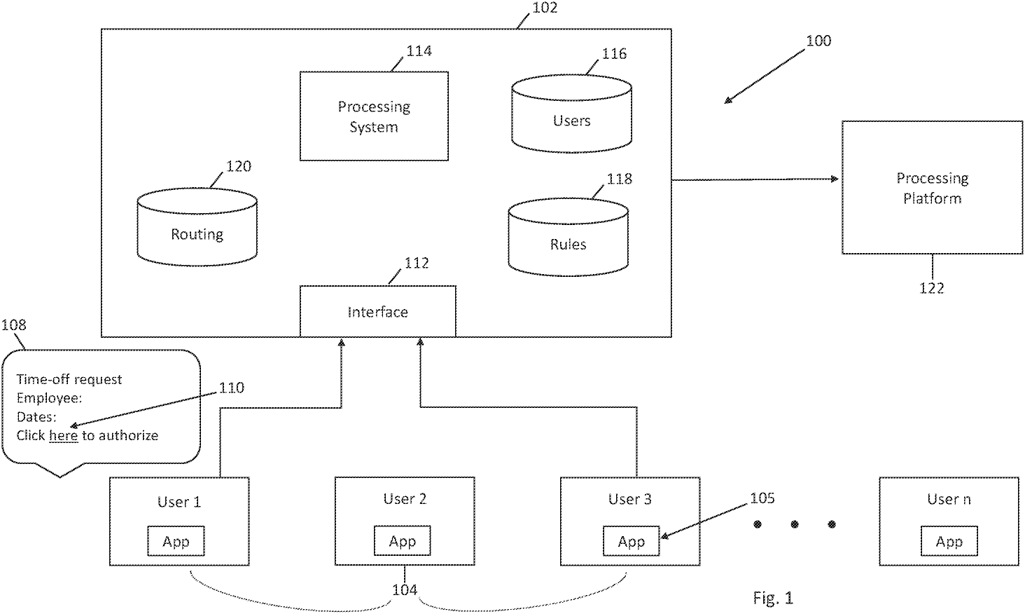

FIG. 1 illustrates an intelligent notification routing system 100 in accordance with the present invention. The system 100 generally includes an intelligent notification routing platform 102 that interacts with a number of user devices 104. In particular, one or more of the user devices 104 may submit an intelligent notification routing request 106 to the platform 102. The platform 102 then processes the request and routes intelligent notification messages 108 to one or more of the user devices 104. The illustrated intelligent notification message 108 includes an interactive element 110. As will be described in more detail below, a user can use the interactive element 110 to execute a variety of functionality.

A variety of different types of user devices 104 may be employed in the system 100. For example, the user devices 104 may include mobile phones, tablet computers, laptop computers, desktop computers or other devices for accessing the platform 102 via wireless, telephonic, and/or data network pathways. In this regard, the requests 106 may be provided in the form of a text message, instant message, data network message, social/business network messaging system, email message, or the like. Similarly, the intelligent notification message 108 may be provided as a text message, instant message, email, user interface screen of an application, or the like. The request 106 and message 108 may be provided in different forms via different modalities.

As will be described in more detail below, the user devices 104 communicate with the platform 102 to implement a variety of functions. Although the platform 102 is illustrated as a single element, it will be appreciated that the platform 102 may be executed on one or more machines (e.g., computers or servers) at a single site or geographically distributed. Each such site may execute the full functionality of the illustrated platform 102 or the functionality may be distributed across sites. Moreover, the functionality may be distributed in various ways between the platform 102, the user devices 104, and other platforms (such as processing platform 122), e.g., some preprocessing of notification information may be executed at the user devices 104 or processing platform 122, for example, to facilitate rapid response or reduce use of processing resources of the platform 102 or communication bandwidth requirements. The platform 102 may be hosted by a system provider or may be implemented separately (e.g., cloud-based) and connected to the system provider via an interface such as API. Moreover, such a system platform may provide notification information to the platform 102.

In one implementation, the request 106 may be generated in connection with a user interface screen of an application 105 running on a user device 104. For example, the user interface screen may include prompts for the user to enter various fields relating to, for example, the intended recipients of notification messages (e.g., identifying specific individuals, or identifying recipients by title, function, group, or other identifier), defining the interactive element 110, defining actions required of various recipients, and defining any contingencies or prerequisite conditions for routing a notification message to one or more of the recipients. In addition, the user may use the application 105 to define and upload forms, links, or other elements to be presented in connection with the interactive element 110. The application 105 may also be used to receive information from the platform 102 and generate the intelligent notification message 108 including the interactive element 110.

The interactive element 110 can trigger a variety of functionality. For example, selection of the interactive element 110, can trigger a predefined response to one or more users, the interactive element may prompt the user to enter specified information for a response, may trigger multiple responses to multiple parties, or may trigger a series of notifications and actions. In this regard, selection of the element 110, or entering information and selecting a “send” or similar function in connection with the element 110, may cause a message to be transmitted to the platform 102. The message may include content and metadata defined by the information entered by the user and the structure of the element 110. This content and metadata can be extracted by the platform 102 and can be used to access and execute rules related to the intelligent notification routing application as defined by the user/context.

The platform 102 includes an interface module 112 for processing communications to and from the user devices 104. For example, the module 112 may receive the request 106, parse the request to identify various fields of information relating to the requested intelligent notification routing project, and provide resulting request information, together with any uploaded materials, to the processing system 114 of the platform 102. The processing system 114 processes the request information to develop an intelligent notification routing process. In this regard, the processing system may access a rules database 118 including routing rules. Such routing rules may include general rules as well as rules that are specific to an organization. For example, such rules may define which individuals within an organization need to receive different types of notifications, what actions are required from different individuals in relation to a given type of notification, what contingencies and prerequisites may need to be satisfied before issuing specific notification messages, and the like.

The processing system 114 may also access a user information database 116. Among other things, the database 116 may: identify users within particular organizations; identify which groups or units of the organization a given user belongs to; define any limitations/requirements concerning who may/must receive particular types of notifications; and store any user preferences such as preferred notification modality, times of day, and the like. In addition, the processing system 114 may access routing information 120 to obtain phone numbers, instant messaging address information, email addresses, and any other information useful to complete routing instructions. At appropriate times, e.g., immediately or upon satisfaction of any contingencies or prerequisites, the processing system 114 may control the interface module 112 to transmit notification message information to the appropriate user devices 104 to generate the intelligent notification messages 108.

The illustrated system 100 also includes a processing platform 122 that may receive outputs from the platform 102 at the end, or at other points, in an intelligent notification process. For example, the processing platform 122 may include scheduling software for scheduling meetings or adding meetings/deadlines to a calendar, a third-party platform for receiving business proposals, an administrative portal for retaining personnel records, or any of various other kinds of platforms.

The intelligent notification message 108 depicts a first intelligent notification context of the present invention. In particular, the illustrated message 108 depicts a message with an embedded interactive element 110 that defines a call to action. That is, a response is executed by selecting the interactive element 110 without the need to enter information or take any further action. In this case, by selecting the interactive element 110, the user authorizes the action set forth in the text of the message 108. For example, such a message 108 may be sent to a manager to authorize a purchase, or authorize other actions such as transmitting an offer, approving a time-off request, or the like. When the user selects the element 110, a response message is transmitted to the platform 102 and appropriate follow-on actions may be initiated, for example, notifying the sender that authorization has been granted, logging a time-off request, or transmitting an offer to a counterparty. Depending on the rules of the organization or the rules defined for the authorization request, if the recipient fails to select the interactive element 110 within a predetermined time, authorization may be deemed to have been denied. Alternatively, the interactive element 110 may include one graphical object to select to grant authorization and another graphical object to select to deny authorization. It will be appreciated that a variety of calls to action may be defined with appropriate interactive elements in accordance with the present invention.

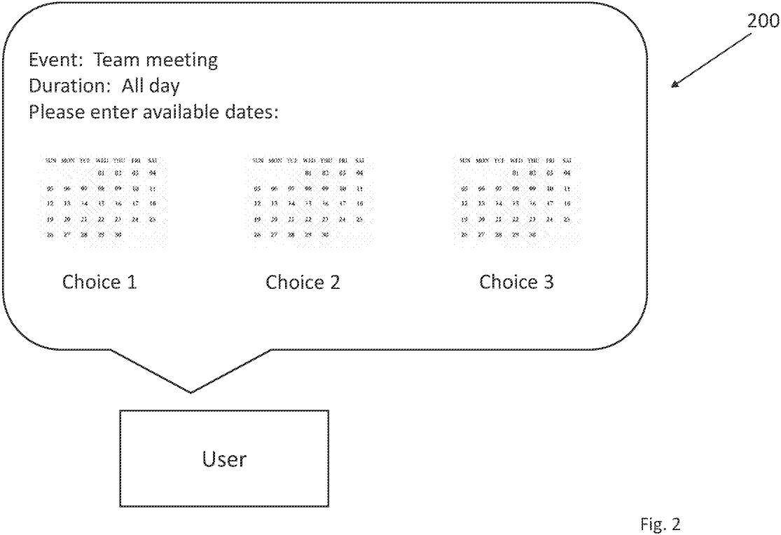

FIG. 2 depicts another intelligent notification context of the invention. In this case, a notification message 200 includes a defined response where the user is prompted to enter information to execute a response to the message 200. Depending on the specific notification message context, a variety of types of information may be solicited such as an address, a date, a product preference, a vote, or the like. In the illustrated example, the message 200 prompts the user to enter up to three date preferences for a team meeting. In this case, the date preferences may be entered via an interactive calendar. Accordingly, the recipient can populate the three date fields and, optionally, hit a send button or the like, to complete the response. The response may be preprocessed by the intelligent notification routing platform, or the response may be sent directly to the sender. For example, a platform may receive responses from multiple recipients and process the responses to determine a result. The platform made determine the results of an election or identify the most favorable date for a proposed meeting. Alternatively, in the illustrated example, responses for multiple recipients may be transmitted to the sender so that the sender can determine a result, e.g., an optimal date for a team meeting.

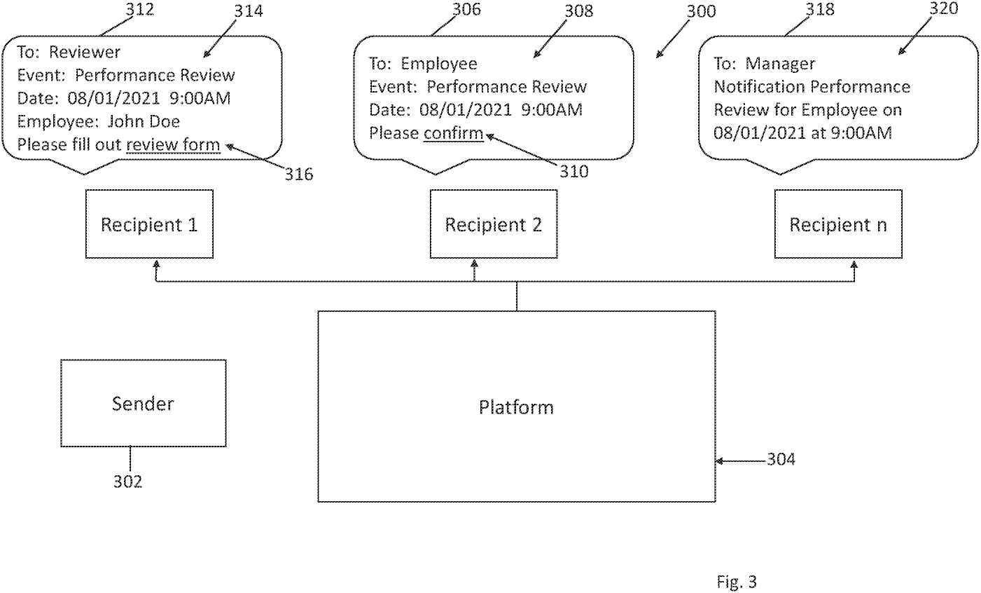

FIG. 3 depicts a further example of a defined response context of the present invention. In this case, multiple, different intelligent notification messages are sent to different recipients based on a single notification request. Specifically, a sender 302 may upload an intelligent notification request to a platform 304 as described above. In this case, the request relates to scheduling an employee performance review and defines a number of different notification messages to be sent to different parties. For example, a notification message 306 may be sent to the employee to be reviewed. The message 306 includes text 308 notifying the employee of an upcoming review and an interactive element 310 for use in providing a response. In this case, the interactive element 310 allows the employee to confirm the scheduled performance review.

One or more reviewers may also receive notification messages for the performance review. In the illustrated example, a reviewer may receive the notification message 312. The notification message 312 includes text 314 notifying the reviewer of the performance review and further includes an interactive element 316 for use in providing a response. In this case, the interactive element 316 is a link to a review form. The reviewer may fill out the review form and return the form in a response to the platform 304. For example, the review form may be stored, forwarded to the employee, and/or forwarded to administrative personnel.

In addition, other recipients such as managers may be notified of the upcoming performance review responsive to the request entered by the sender 302. Thus, a manager may receive a notification message 318 concerning the upcoming performance review. The illustrated message 318 includes text 320 notifying the manager of the upcoming performance review. The message 318 may or may not include an interactive element, for example, acknowledging or approving the upcoming performance review.

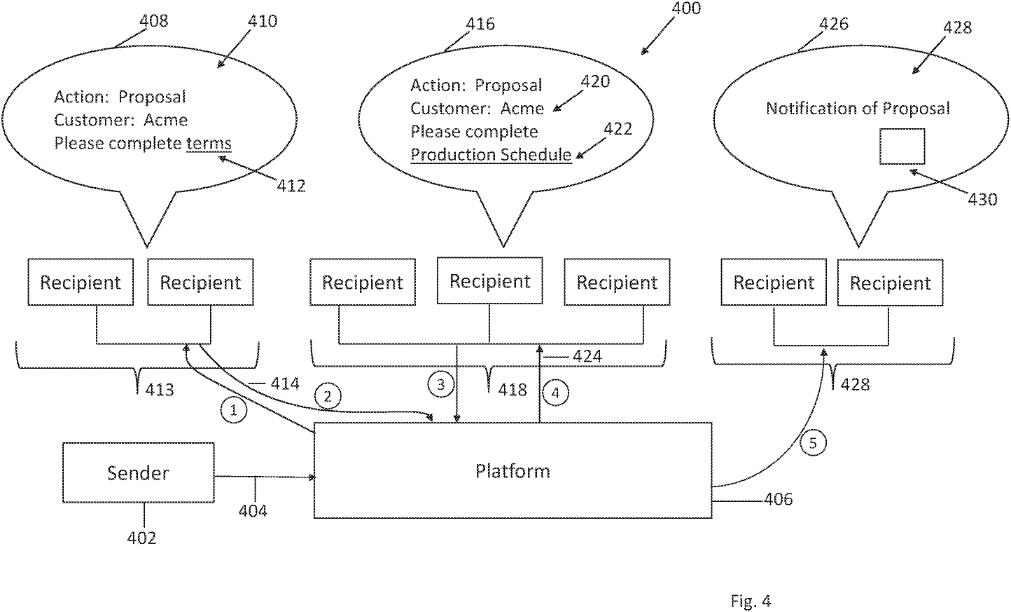

FIG. 4 illustrates a still further intelligent messaging context of the present invention. As noted above, an intelligent notification process may involve a series of notifications and actions relating to an intelligent notification request. For example, in a complex, multilateral intelligent notification process, some actions and notifications may be contingent upon certain events or require certain prerequisites, e.g., before a notification is sent to a specific recipient. FIG. 4 illustrates such a complex, multilateral intelligent notification process 400. The process 400 is initiated by a sender 402 who sends an intelligent notification request 404 to an intelligent notification platform 406. In the illustrated example, the request 404 relates to a business proposal such as a response to a request for proposal from a potential customer. In this case, a first intelligent notification message 408 may be sent to one or more first recipients 413, for example, project managers. The illustrated message 408 includes text 410 defining the proposal that is solicited together with an interactive element 412. The illustrated interactive element 412 includes a term sheet that the first recipients can complete to define the terms of the proposal such as quantity, price, and the like. The term sheet is then returned to the platform in response message 414.

Upon receiving the response 414, the platform 406 may send an intelligent notification message 416 to one or more second recipients 418. For example, the second recipients 418 may be production managers who are tasked with determining a schedule for the proposal based on the availability of materials and other resources. Accordingly, the message 416 may include text 420 defining the proposal and an interactive element 422. It will be appreciated that the text 420 may be determined at least in part based on the response 414. For example, certain proposal terms such as the product specifications and quantity may be included in the text 420. Thus, the message 416 including the text 420 may not be fully defined at the time of the request 404. In this case, the interactive element 422 may include, for example, proposed delivery dates for deliverables under the proposal. Once this information is populated, a response 424 may be sent to the platform 406.

The platform 406 can then generate a final proposal based on the responses 414 and 420. For example, predefined fields of a proposal may be populated with information from the responses 414 and 420. In the illustrated example, a further intelligent notification message 426 may be sent to third recipients 428. For example, the message 426 may solicit approval of the proposal from one or more officers of the company. In this regard, the illustrated message 426 may include text 428 and an interactive element 430. For example, the interactive element 430 may be a call-to-action element such as an approval button.

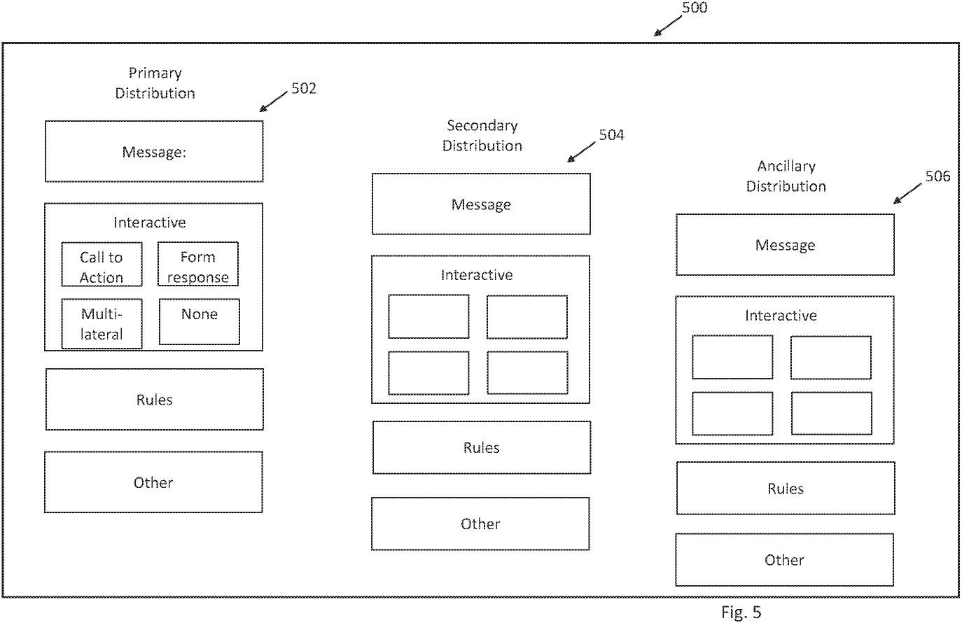

FIG. 5 is a schematic diagram of a user interface 500 that may be used to define and submit an intelligent notification request. For example, such a screen 500 may be presented by an application running on a user device. The screen 500 may be presented after the sender has entered certain information about the intelligent notification request such as the type of request (e.g., call to action, defined response, or complex, multilateral), the subject matter of the request (e.g., meeting request, performance review, or business proposal), the company or business group, and the like. Based on this information, the platform can select an appropriate user interface for the request as well as access/define the appropriate rules for handling the request. As shown, the interface may include a first section 502 for defining a primary distribution for the request, a second section 504 for defining a secondary distribution for the request, and one or more additional sections 506 that can be used to define any subsequent distribution. In each section 502, 504, or 506 user interface elements may be provided to define the text of a notification message, any interactive element, and rules related to distributions such as any contingencies or prerequisites. This information can then be used to define the interactive elements(s) of an intelligent notification request, to associate metadata with responses, and to define fields of information and values for responses. It will be appreciated that additional user interface elements can be provided and that the user interface screens may be customized for the needs of particular organizations.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed:

1. A method for processing notifications in a communications network, comprising:
receiving, via said communications network, a notification request from a sender, said notification request including instructions for distributing a notification and for prompting one or more responses;
based on said instructions, 1) identifying one or more recipients for said notification request, 2) generating one or more notification messages, and 3) embedding a first interactive element into at least a first notification message of said notification messages;
routing said first notification message to at least a first recipient of said recipients; and
receiving a response from said first recipient based, at least in part, on selection of said first interactive element.

2. The method of claim 1, wherein said first message comprises one of a text and an instant message.

3. The method of claim 1, wherein said first interactive element of said first message comprises a call to action wherein said response is completed by selecting said first interactive element.

4. The method of claim 3, wherein selection of said first interactive element indicates one of an acknowledgment and an approval.

5. The method of claim 1, wherein said first interactive element comprises a form response wherein said first recipient is required to interact via said first interactive element to enter information to execute said response.

6. The method of claim 5, wherein said first recipient interacts via said first interactive element by populating data fields or completing a form.

7. The method of claim 1, wherein said routing comprises selectively routing notification messages to multiple recipients wherein said selectively routing to at least one of said recipients is contingent on satisfaction of a condition.

8. The method of claim 1, wherein said condition comprises verifying satisfaction of a response relating to routing of a notification message to another of said recipients.

9. A system for processing notifications in a communications network, comprising:
an input module for receiving, via said communications network, a notification request from a sender, said notification request including instructions for distributing a notification and for prompting one or more responses; and
a processor operative for:
based on said instructions, 1) identifying one or more recipients for said notification request, 2) generating one or more notification messages, and 3) embedding a first interactive element into at least a first notification message of said notification messages;
routing said first notification message to at least a first recipient of said recipients; and
processing a response from said first recipient based, at least in part, on selection of said first interactive element.

10. The system of claim 9, wherein said first message comprises one of a text and an instant message.

11. The system of claim 9, wherein said first interactive element of said first message comprises a call to action wherein said response is completed by selecting said first interactive element.

12. The system of claim 11, wherein selection of said first interactive element indicates one of an acknowledgment and an approval.

13. The system of claim 9, wherein said first interactive element comprises a form response wherein said first recipient is required to interact via said first interactive element to enter information to execute said response.

14. The system of claim 13, wherein said first recipient interacts via said first interactive element by populating data fields or completing a form.

15. The system of claim 9, wherein said routing comprises selectively routing notification messages to multiple recipients wherein said selectively routing to at least one of said recipients is contingent on satisfaction of a condition.

16. The system of claim 9, wherein said condition comprises verifying satisfaction of a response relating to routing of a notification message to another of said recipients.
